(19) United States
(12) Patent Application Publication
(10) Pub. No.: US 2003/0210259 A1
(43) Pub. Date: Nov. 13, 2003

(54) Multi-tactile display haptic interface device

(76) Inventors: Alan V. Liu, Rockville, MD (US); Christoph R. Kaufmann, Tigard, OR (US)

Correspondence Address: MORRISON & FOERSTER LLP, 1650 TYSONS BOULEVARD, SUITE 300, MCLEAN, VA, 22102, US

(21) Appl. No.: 10/293,926

(22) Filed: Nov. 14, 2002

Related U.S. Application Data
(60) Provisional application No. 60/331,320, filed on Nov. 14, 2001.

(51) Int. Cl. G09G 5/00

(52) U.S. Cl. 345/702

(57) ABSTRACT

A tactile array is integrated with a large scale force-feedback device. Under software control, the large scale force-feedback device provides large scale shape information while the tactile display provides fine structures and surface texture. In a virtual reality environment, the concept of a “tactile map” is employed. A tactile map provides surface details and is rendered by the tactile array. Tactile maps may be based on actual object surface properties, or they may be arbitrarily generated based on the application. In operation, the effect of colliding with a object is produced and the point of contact is noted. The corresponding location on the tactile map is identified, and the surface features are rendered on the tactile array. Moving the point of contact changes the corresponding portion of the tactile map being rendered.

### REFERENCE TO RELATED APPLICATIONS

This application claims priority to U.S. Provisional Application No. 60/331,320, of the same title, and filed Nov. 14, 2001.

### RIGHTS IN THE INVENTION

This invention was made with support for the United States government, and the United States government may have certain rights in the invention.

### BACKGROUND OF THE INVENTION

1. Field of the Invention

The invention generally relates to a method and device for simulating a sense of touch relating to large scale forces and textures in a single interface.

2. Description of Background

A haptic interface is a system for imparting tactile sensations (e.g., contact forces, temperature, humidity, and electrical impulses) and force feedback, thereby permitting a computer to simulate a sense of touch for the user. Haptic interface devices are used to enhance sensory feedback and have applications in telerobotics and, virtual reality (U.S. Pat. No 5,771,181). Current haptic interface devices are capable of only a limited range of forces and sensations. For example, they can either simulate large scale haptics, e.g., large scale contact forces, or small scale haptics, e.g., delicate contact forces, but generally not both.

A telerobot consists of paired master and slave units; each unit located in different environments. For example, telerobots can be used in hazardous environments to protect a human operator. In this situation, the operator is protected in a safe location while the slave unit operates in the dangerous location. The master unit has control linkages where the human operator places his arms. The slave unit is typically equipped with robotic arms. The slave mimics motion of the master control linkages. When the slave unit's arms strike a solid object, such as a wall, a master unit with haptic feedback freezes motion of its master linkages, simulating the collision. Similarly, when the slave unit lifts a heavy object, the master linkage increases its resistance, simulating the greater effort required.

Virtual reality applications also benefit from haptic interfaces because the believability of the virtual environment is enhanced by the presence of a haptic interface. For example, haptic interfaces are used to simulate the resistance of a needle passing through skin, or to simulate hard cancerous tissue in a prostate or breast examination. Accurately simulating haptics is a complex task. For example, the range of forces varying between large scale and small scale haptics large scale is large. Particularly, large scale forces that define weight and collisions with surfaces of various types are at least several orders of magnitude greater than the subtle forces that define smooth, rough, and sticky surface texture.

Sensible Technologies, Inc., provides a device, referred to as the “Phantom,” for simulating large scale force haptic feedback. The Phantom is a force feedback device designed to simulate point contact forces. Several different types of Phantoms are available, and differ primarily in the volume of space covered. FIG. 1 illustrates Phantom devices 110, 120 and 130. In operation, the user grasps a Phantom by an end-effector (111, 121, 131 in the Figure), which is a pen-like attachment connected to the Phantom by an arrangement of joints. Sensors on each joint report the end-effector's position and orientation to the host computer. In addition, actuators on the device can generate forces reproducing various effects. By using the end-effector to probe virtual space, the device provides users with the sensation of touching various objects. The Phantom can simulate collisions with surfaces of varying hardness, movement through media of varying viscosity, and some surface properties, such as frictionless surfaces, smooth, or bumpy surfaces. See U.S. Pat. Nos. 5,898,599; 5,625,576; and 5,587,937. Other types of conventional force feedback devices are described in U.S. Pat. Nos. 5,354,162, 5,784,542, 5,912,658, 6,042,555, 6,184,868, 6,219,032 and 5,734,373.

A disadvantage of force-feedback devices is the limited feedback available. Such devices simulate the equivalent of “feeling” an environment with a pointing device such as a stick. For more sophisticated applications in virtual reality, such as simulating a medical procedure where feedback of delicate texture information and other sensations is important to a surgeon, this is inadequate. For example, it is difficult, if not impossible, to simulate palpating prostate tumors with a conventional device. Subtle contact forces and object textures that are detectable by the fingertip cannot be accurately replicated using these devices. Similarly, other sensations such as temperature and humidity cannot be reproduced.

One conventional technique for simulating surface sensations is to use an array of texture elements arranged in a regular grid pattern. A texture element is capable of producing sensation at a point. Sensations include contact forces, heat, cold, electricity, and others. By activating groups of elements, various patterns of sensations may be produced. A tactile array is an example. Its texture elements consists of pins that may be raised and lowered. The user's finger is in contact with the array's surface. Depending on the configuration and height of the raised pins, different types of textures may be simulated. A common application of tactile arrays is electronically driven Braille displays. Tactile arrays may be large, e.g., about the size of the palm, or small, e.g., about the size of a fingertip. They typically contain large numbers of pins and are statically mounted. U.S. Pat. No. 5,165,897 describes a tactile display device that can be attached to the fingertips. Other types of tactile displays are described in U.S. Pat. Nos. 5,583,478, 5,565,840, 5,825,308, 5,389,849, and 5,055,838.

VirTouch Ltd., developed a haptic mouse for simulating delicate textures. The mouse, shown as 210 in FIG. 2, includes three tactile arrays 230, 240 and 250. In operation, a user's index, fore, and ring finger rest on an array. Moving the mouse changes the texture on each array and allows a user to feel the outlines of icons and other objects displayed on a computer desktop. This device is particularly suited to assist the vision impaired in using a computer. However, a disadvantage exists in that the device is unable to provide the user feedback relating to gross large scale forces, such as those arising from collisions with surfaces of varying hardness. Other types of similar conventional haptic computer interface devices are described in U.S. Patent Application Publication Nos. 2001/0002126 and 2001/0000663, and U.S. Pat. Nos. 5,898,599, 5,625,576, and 5,587,937.

Because sophisticated applications, such as virtual medical procedures, require multi-tactile sensations which conventional devices are unable to simulate, there exists a need for a single haptic interface that is able to simulate both large scale forces and subtle contact forces and textures.

### SUMMARY OF THE INVENTION

The present invention overcomes the problems and disadvantages associated with current strategies and designs and provides systems, devices and methods that provide a haptic interface simulating both large scale haptics and small scale sensations for increased haptic fidelity.

One embodiment of the invention is directed to a multi-tactile haptic interface apparatus comprising a force-feedback element, one or more tactile arrays connected to the force-feedback element, a locating element for determining a position of each tactile array wherein the force-feedback element and the one or more tactile arrays simulate both a large scale force and a surface texture as a function of the position. The apparatus may further interface one or more human body parts, such as fingers or hands, with the one or more tactile arrays. An advantage of a large scale haptic device (or small scale tactile feedback device) is that large volumes of space are not required. Another advantage is a greatly expanded range of dynamic forces. Another advantage is the ability to combine large scale forces with a variety of other subtle sensations.

Another embodiment of the invention comprises a multi-tactile interface system comprising a haptic interface and a virtual reality generator wherein the generator generates one or more electrical signals that correlates with a magnitude of large scale force and/or a type of surface texture. The virtual reality generator may also generate one or more tactile maps of one or more objects in a virtual environment, associate a position with a location on the one or more tactile maps or wherein the magnitude of the force and the type of surface are determined by the location on the one or more tactile maps. Another embodiment of the system comprises a device that provides temperature information to a user. Temperature information provided simulates the temperature at the various locations in the virtual environment. Another embodiment of the system comprises a device that provides electrical stimulation to the user's hand depending on its location in space. Such systems may be used for medical simulated training; entertainment; and virtual reality games.

Another embodiment of the invention is directed to methods comprising the steps of providing a tactile map of an object in a virtual environment, determining a position of a tactile interface, identifying a location on the tactile map corresponding to the position, and generating a large scale force and a surface texture associated with the location. Such methods may further comprise the steps of tracking changes in position of the tactile interface, and modifying the large scale force and the surface texture corresponding to the changes.

Another embodiment of the invention is directed to methods for simulating an exercise by connecting a user to the multi-tactile haptic interface apparatus of the invention and performing the exercise. The exercise may be for medical training, such as surgical training, or simply for enjoyment such as in performing a virtual reality game.

Other embodiments and advantages of the invention are set forth, in part, in the following description and, in part, may be obvious from this description, or may be learned from the practice of the invention.

### DESCRIPTION OF THE FIGURES

FIG. 1 illustrates large scale force feedback devices.

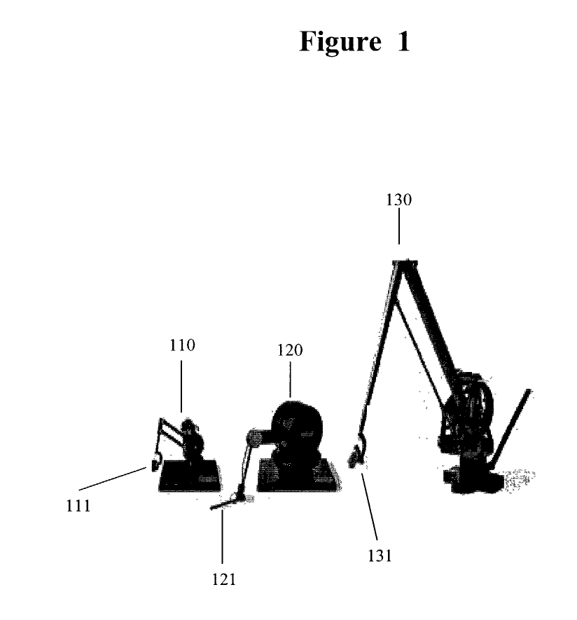

FIG. 2 illustrates a haptic mouse device.

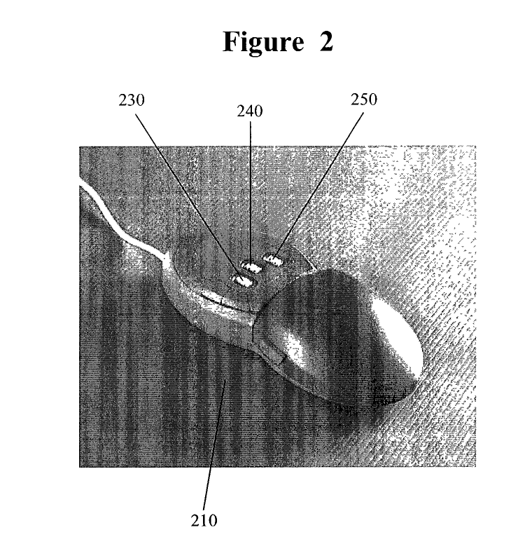

FIG. 3 illustrates an embodiment of the invention.

FIG. 4 illustrates (left) a polygonal model of a mannequin wherein individual triangular tiles are visible, and (right) the same model with a texture map applied.

### DESCRIPTION OF THE INVENTION

As embodied and broadly described herein, the present invention is directed to systems and methods for simulating a sense of touch in devices. More specifically, the present invention relates to systems, devices and methods that provide a haptic interface simulating both large scale haptics and small scale sensations for increased haptic fidelity.

One embodiment of the invention is directed to a multi-tactile haptic interface apparatus comprising a force-feedback element, one or more tactile arrays connected to the force-feedback element, a locating element for determining a position of each tactile array wherein the force-feedback element and the one or more tactile arrays simulate both a large scale force and a surface texture as a function of the position. The apparatus may further interface one or more human body parts, such as fingers or hands, with the one or more tactile arrays. An advantage of a large scale haptic device (or small scale tactile feedback device) is that large volumes of space are not required. Another advantage is a greatly expanded range of dynamic forces. Another advantage is the ability to combine large scale forces with a variety of other subtle sensations.

A preferred embodiment focuses primarily on handsets in virtual reality applications rendering large scale force feedback and small scale tactile sensations. The invention may also be practiced in other applications and provide tactile sensations to other parts of the body such as the wrists, one or more toes, the forehead, a cheek, neck, trunk, arm, leg, foot, ear and other skin surfaces. A desirable embodiment of the invention features a fine tactile array integrated with a large scale force-feedback device. Such an integration provides both large scale shape information and fine surface texture. In a preferred embodiment, a tactile array is disposed on an end-effector of a large scale force-feedback device. By combining the tactile array as a second haptic device with the large scale force tactile device, into a single mechanical unit, a greatly expanded range of tactile effects can be reproduced. As a result, increased haptic fidelity is obtained. For example, devices according to embodiments of the invention can provide more detailed information that combines not only surface information over a 1 cm to 1000 cm sized object, but also fine detail surface information with respect to small surface irregularities less than 1 cm in size.

In operation, a user's body part(s) such as one or more fingers are placed in contact with the tactile array. Under software control, the large scale force-feedback device provides large scale shape information while the tactile display provides fine structures, surface texture, and other sensations as the tactile array is moved by the user. The invention may also include video images or auditory sounds that simulate a desired environment and are provided directly to the user. These images and sound would be designed to correspond to the virtual environment and thereby provide a realistic look and sound to any simulation. Further, the invention may include temperature sensations that simulate temperatures changes that would be perceived by a user.

One of the many applications of the invention is medical training and education. Particularly, the invention may be used to simulate diagnostic scenarios in prostate examination. Conventionally, a large scale force-feedback device by itself can only provide the general shape and appearance of the prostate, but cannot render the small, hard lumps characteristic of suspected tumor tissue. Moreover, conventional tactile displays render small lumps, but cannot define the general shape of the organ. The present invention renders both, thereby providing a realistic examination to be simulated. The apparatus may also be used for performing most any exercise including surgical procedures and other medical exercises, and virtual reality games that involve a sensation of touch and/or texture of a surface.

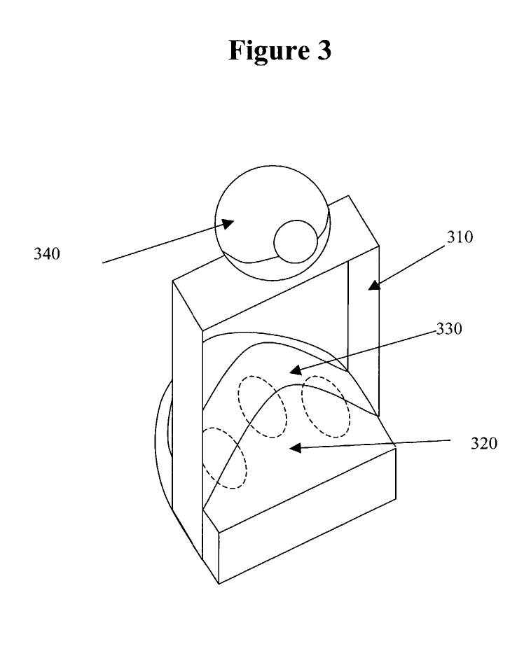

In a particular embodiment, a rigid frame is used to attach the tactile array to join it to the large scale force-feedback device. FIG. 3 illustrates frame 310 that holds base 320 and strap 330. The entire assembly is held by clamp 340. However, any type of attaching means may be used to provide a connection between the two. Clamp 340 at the top of frame 310 attaches the assembly to an end-effector (not shown). The assembly is clamped as close to the jointed end of the end-effector as possible. During operation, the user places his fingers on the tactile display and is secured in place by a strap. Movement of the user's hand is reported by a tracking mechanism (a locating element) on the force-feedback device. When a virtual object is encountered, the force-feedback device provides the appropriate reaction forces to simulate contact with the object. Simultaneously, elements on the tactile display are activated to render small scale tactile features on the object's surface. As the user moves his finger over the object, the rendered surface detail on the tactile display changes to match the location of the user's fingers on the virtual object.

One or more heating or cooling elements such as an electric resistor, coiled wire, or peltier device responsive to a variable control, may be added to the user interface to provide differential temperature sensations directly to the user to more closely approximate a realistic experience. In an embodiment one or more peltier devices are attached to different parts of the haptic interface system surface that contacts the user's body. Most desirably, each peltier device has another surface that is connected to a thermal mass, such as a block of aluminum, to acts as a heat reservoir to assist pumping heat into or out of the haptic system. Air movement to and from one or more locations of the user interface may be controlled and effected by puffs of air through tubes or other devices. The air may be cooled, heated, dried or made moist as suited for a realistic experience in embodiments where the user interface allows contact with uncovered skin. In addition, a video or audio device simulating the virtual environment can be worn by the user, again to more closely approximate a realistic experience.

In an embodiment a locating element may be used to coordinate the position of the one or more tactile arrays with the force feedback element with respect to a fixed position in space. In many embodiments the entire surface of a tactile array assumes a constant position with respect to the force feedback element, in which case the locating element may be one or locations on either the force feedback element, the tactile array, or both.

The locating element is used to provide 3 dimensional location information to the computation portion of an apparatus, or associated equipment, so that movement of the user interface is constantly monitored. The locating element may be any of number of contrivances as will be appreciated by a skilled artisan. For example, the locating element may be one or more reflectors, from which positional information can be directly or indirectly determined by light source interaction and light detection. Such reflector may consist of a simple light or infrared or radiowave (such as microwave) reflector or may be more complex, such as a pattern of concentric lines. By way of example, one or more laser beams may be used to shine upon a surface of parallel lines attached to one or more parts of the movable device(s) and that reflect the laser light output. Movement of either the laser(s) or the reflecting surface can be monitored by light detectors. The locating element may comprise one or more light emitters or light detectors affixed to the force-feedback element and/or tactile array(s) such as infra red or visible light laser(s). Other types of electromagnetic energy such as microwaves of course can be used and serve to provide locational signals using a fixed receiver or set of receivers that can track the signal to provide the information. A locating element for a tactile sensor also may be a piezoelectric device that reports on flex movement or stress between the sensor and another solid such as the hand or a force-feedback element.

The locating element may be built into the mechanical attachment of the force feedback element. For example, one or more suspending rods, pistons, wires or the like that are held by a table, wall, ceiling, or other base, may be moved or may support movement of another part such as a sleeve along the length of a support mechanism. Movement may be monitored from this locating element by light pulse, magnetic field measurements or other detection systems as are known in the art, particularly in the automated factory systems field. For small movements, hall effect devices are particularly useful, and are well known. A large variety of systems are known for monitoring position and/or movement and two or more may be combined as the locating element for a tactile array and/or force-feedback element.

In an embodiment two or more locating elements are used to locate two or more positions of one or more tactile arrays. This embodiment provides some limited freedom for measured movement of tactile array(s) with respect to a force feedback element. For example, provision of one tactile array on the end of each finger of a hand, along with a locating element on each tactile array, allows a user to both move the hand with respect to a fixed point and move the fingers with respect to the hand, with constant and independent monitoring of positions for the hand and the fingers. In a desirable embodiment, a locating element (such as an optical monitor of suspension wires or pistons that hold the hand in space) monitors hand location, and optical measurements with lasers and light detectors monitor movements of the tactile elements on the fingers.

In an ideal haptic interface, the weight and inertia of the device should not be apparent to the user. When attached to the large scale force-feedback device, the tactile display's weight is sufficient to interfere with operation of the device. Without the users fingers attached to the tactile display, the device may quickly fall. One method of neutralizing the weight is to cause the force-feedback device to exert just enough force to counter the weight of the tactile display. If gravity compensation is properly applied, the tactile display will remain in place even if unsupported by the user.

Haptic rendering on both the force-feedback device and the tactile array must be synchronized to realistically present virtual objects. The host computer controlling both devices must be programmed to effect this synchronization and sufficiently fast to respond to user movement in a natural fashion. Excessive latency between movement and rendering will lead to unrealistic tactile feedback. The problem of simultaneously rendering large scale and fine structures is solved by using one or more of the methods employed to texture maps in computer graphics. For example, U.S. Pat. Nos. 6,448,968; 6,456,287; 6,456,340; 6,459,429; 6,466,206; 6,469,710; 6,476,802; 6,417,860; 6,420,698; 6,424,351 and 6,437,782 describe representative methods for texturing maps and related manipulations and are incorporated by reference in their entireties, particularly the portions that describe methods for computer generating texture maps. Further, a video and/or audio display may be added that shows images and provides audible information of the virtual environment that are synchronized with the location of the tactile array in the virtual environment.

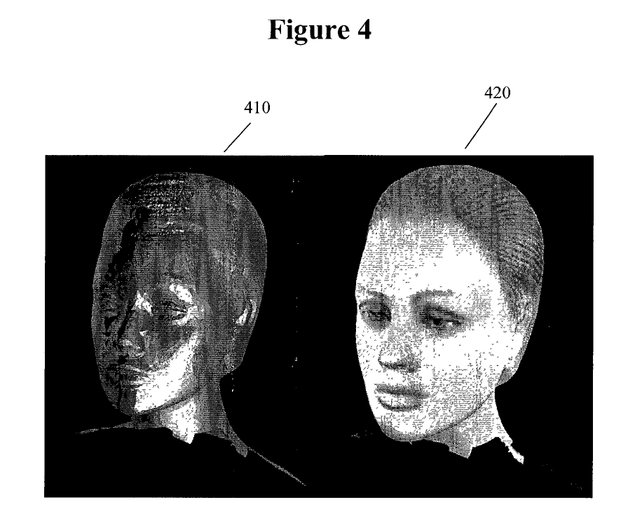

Texture maps can present fine visual detail without requiring a complex underlying model. A common method of representing objects in computer graphics comprises the use of polygons, typically triangles. For example, the object's surface is tiled with triangles. If individual triangles are small, the contours of the object can be closely approximated. By shading each triangle differently based on physical light models, realistic visual renderings are accomplished. The left image 410 in FIG. 4 illustrates a mannequin's face constructed using polygons. Similarly, polygonal models can be used to generate large scale haptic feedback. When the user touches the model, reaction forces are computed based on the angle and degree of contact.

While polygons can efficiently represent object shapes, they are inefficient representations of visual surface detail such as eyelashes and blemishes. Texture maps permit the relatively simple polygonal models to be used without sacrificing visual detail. A texture map is a digital picture wrapped over the polygonal model. Visual details are derived using pictures taken from a real environment and the polygonal model provides the underlying object contours. Right image 420 of FIG. 4 illustrates the same face model with a texture map applied.

In the present invention, the concept of texture maps is applied to haptic rendering, thereby providing a “tactile map.” A tactile map provides tactile surface details and is rendered by the tactile array. Tactile maps may be based on actual object surface properties, or they may be arbitrarily generated based on the application. More than one tactile map can be applied to the same object if a variety of small scale sensations (such as temperature and pressure) are required.

During operation, a user moves one or more body parts such as fingers when attached to devices according to embodiments of the invention. Attachment is preferably with a strap securing the hand to the device, but can be with any suitable attachment mechanism known to those of ordinary skill in the art. Finger position and orientation are tracked. When an object is encountered, the force-feedback device reacts by generating an appropriate resistance. The effect of colliding with the object is produced and the point of contact is noted. The corresponding location on the tactile map is identified, and the surface features are rendered on the tactile array. Moving the point of contact changes the corresponding portion of the tactile map being rendered.

In a desirable embodiment a two dimensional tactile array of pins is combined with a force feedback device. The pins preferably are electrically operable and may, for example, comprise electromagnets and/or piezoelectric actuators. The two dimensional array may be flat, curved or an irregular shape. In an embodiment the array is sized and shaped to contact the end of a finger. In another embodiment two or more arrays are used that are coupled to two or more fingers. In yet another embodiment the array is sized and shaped to contact the palm of the hand. In yet another embodiment two arrays are sized and shaped to envelop a hand, with one array contacting the palm and the other contacting the back of the hand. In this latter embodiment the arrays may be brought together by a common mount and the common mount may be adjusted and used as a force-feedback device for generating resistance. Accordingly, the entire device may resemble a glove that is firmly fixed in space to a large scale force feedback device but that has one or more fine tactile feedback surfaces to render texture information. In yet another embodiment the array of pins is shaped to fit another body part.

In an embodiment a tactile array comprises a pad between 0.2 and 500 square centimeters in area and more desirably between

0.5 and 150 square centimeters in area. The array may have at least 10, 25, 50, 100, 200, 500, 1000, 2000, 5000 or even more pins. The pins may have blunt ends, rounded ends or other shaped ends. Spaces may exist around each pin. The pins may be moved through graduated distances by action of an actuator such as a piezo electric, fluidic or solenoid actuator. The pins may exert graduated pressure without movement. By controlling the rise and fall (or protrusion distance) of each pin, a variety of patterns may be produced, as will be appreciated by a skilled artisan. In an embodiment each pin controllably vibrates at a controlled frequency or frequencies. In another embodiment the array comprises a flat surface having one or more matrices of x-y addressable solid state elements, wherein each element upon activation creates a localized movement. The matrix of elements may be sandwiched within a flexible covering for contact with the body part. If a finger is attached to a tactile array such as an array of pins or matrix of movable elements, different types of textures can be felt. Since the tactile array is attached to the large scale forces haptic interface, additional information such as the shape and hardness of the virtual object can be rendered. In this way a device according to embodiments of the invention can reproduce both large scale contact forces that define the overall shape of an object as well as file contact forces that define surface texture such as bumps, lumps and thin ridges.

In another embodiment of the invention, a multi-tactile joystick comprises a force-feedback joystick with tactile displays on the handle. Force feedback joysticks provide a variable amount of resistance when the user pushes the stick in an arbitrary direction. Other effects such as a force impulse (i.e., a sudden jerk) or strong vibrations can be generated. Covering the handle with a tactile array can increase the range of tactile sensations. In addition to generating large scale haptic forces, the tactile array can simultaneously render small scale tactile effects. These may be contact, vibratory, or electrical displays of arbitrary density.

During operation of one embodiment, a user grasps the joystick handle. In addition to large scale haptics typical of a force-feedback joystick, the multi-tactile joystick provides additional information to the user through the tactile displays on the handle. For example, in a game application, the tactile display alerts the user of approaching opponents. The strength of the effect and the portion of the handle producing that effect indicate the proximity and direction of approach.

In another embodiment of the invention, a mouse features multi-tactile sensations. Force-feedback mice provide a variable amount of resistance when the user moves the mouse. The effect can be used to generate an inertia effect when folders or icons are dragged about the computer desktop. The degree of inertia can be made to correlate with the size of the folder. Other effects such as detecting the edge of a window can be generated.

In a desirable embodiment, a tactile display is added to a mouse body to stimulate the user's palm. In addition to inertia effects, small scale tactile effects are generated. Applications include guiding a user to the location of a particular file. The user is prompted to move the mouse in a direction dictated by selective activation of the tactile array. Other applications include suggesting areas of interest on a web page. The user is alerted to links of interest by activation of the tactile display.

In certain embodiments, other small scale tactile sensations may be simulated. For example, vibro- and/or electro-tactile sensations. Vibro-tactile sensations are experienced when contact is made with a vibrating object (e.g., an electric buzzer). Electro-tactile sensations are felt when low level current passes through the skin surface to provide a tingling sensation in the user. The present invention is particularly suited for including vibratory and electrical tactile displays in addition to those capable of rendering contact forces.

The large scale force-feedback element, for providing a large scale force, and the fine tactile array(s), for providing surface texture most advantageously are coupled together by a known position that may be fixed or alterable. A computer generally is used to analyze and output forces and the two types of forces, the large scale force and tactile array forces should be coordinated in space. For embodiments where the tactile array(s) are of fixed shape and of fixed spacial relationship to the large scale force-feedback element, the location of both with respect to each other will be known at all times. However, for other embodiments wherein a tactile array shape itself changes, and/or the spacial relationship of a tactile array with the force-feedback element changes, a mechanism is advantageously used to monitor their relationship in three dimensional space.

The present invention focuses on simulating the most accurate and realistic tactile sensations. The invention is particularly suited for use with devices simulating other senses, such as auditory and visual senses with an audiovisual headset. In a desirable embodiment, a user may operate one or more multi-tactile handsets such as, for example, one for each hand, to more accurately simulate medical surgery. An audiovisual headset provides a surgeon with audio and visual feedback. Each handset provides the surgeon with force feedback and texture information in the virtual surgery. For a more realistic simulation, the surgeon may use actual surgical instruments interfaced with the tactile displays.

In another embodiment one or more tactile feedback devices become attached to the surgeon's hand by a glove, with tactile sensors contacting the skin of the hand on the inside of the glove. The surgeon can don and doff the glove and, in an embodiment may use a foot switch to activate a sealing mechanism and/or engage a large scale force interface device that may hold the glove in a fixed position.

Other embodiments and uses of the invention will be apparent to those skilled in the art from consideration of the specification and practice of the invention disclosed herein. All references cited herein, including all U.S. and foreign patents and patent applications, are specifically and entirely hereby incorporated herein by reference. It is intended that the specification and examples be considered exemplary only, with the true scope and spirit of the invention indicated by the following claims.

1. A multi-tactile haptic sensory apparatus comprising:
a force-feedback element; and
one or more tactile arrays connected to the force-feedback element,
wherein said force-feedback element simulates a large scale force and said one or more tactile arrays simulate one or more surface properties.

2. The apparatus of claim 1 further comprising a fastener that holds said one or more tactile arrays in contact with one or more body parts.

3. The apparatus of claim 2 wherein the one or more body parts are fingers.

4. The apparatus of claim 2 wherein the one or more body parts are hands.

5. The apparatus of claim 1 further comprising a locating element for determining a position of each tactile array.

6. A multi-tactile interface system comprising:
the haptic interface of claim 1; and
a virtual reality generator,
wherein said generator generates one or more electrical signals that correlate with a magnitude of said large scale force and at least one type of said surface texture.

7. The system of claim 6 wherein said virtual reality generator generates one or more tactile maps of one or more objects in a virtual environment.

8. The system of claim 7 wherein said virtual reality generator associates at least one position with a location on said one or more tactile maps.

9. The system of claim 8 wherein the magnitude of said force and the type of surface are determined by said location on said one or more tactile maps.

10. The system of claim 7 further comprising a video headset for viewing said simulated environment.

11. The system of claim 10 wherein images provided to said video headset correspond to positions of said one or more tactile arrays in said simulated environment.

12. The system of claim 8 further comprising a heating element connected to the interface that provides variable temperature information.

13. The system of claim 12 wherein the temperature information provided simulates the temperature at said location in said virtual environment.

14. A computational method comprising the steps of:
providing a tactile map of an object in a virtual environment;
determining a position of a tactile interface;
identifying a location on said tactile map corresponding to said position; and
generating a large scale force and a surface texture associated with said location.

15. The method of claim 14 further comprising the steps of:
tracking changes in position of said tactile interface; and
modifying said large scale force and said surface texture corresponding to said changes.

16. The method of claim 15 wherein the changes in position of said tactile interface correspond to changes in the virtual environment.

17. A method for simulating a medical exercise comprising:
connecting a user to a multi-tactile haptic interface apparatus comprising a force-feedback element, one or more tactile arrays connected to said force-feedback element, and a locating element for determining a position of each tactile array wherein said force-feedback element and said one or more tactile arrays stimulate both a large scale force and a surface texture as a function of said position; and
performing said medical exercise with said apparatus.

18. The method of claim 17 wherein said medical exercise is a surgical procedure

19. The method of claim 17 wherein the apparatus simulates a plurality of medical exercises.

20. A method for performing a simulated exercise comprising:
connecting a user to the multi-tactile haptic interface apparatus of claim 1; and
performing said exercise with said apparatus.

21. The method of claim 20 wherein the simulated exercise is a virtual reality game.
